(19) United States
(12) Patent Application Publication
(10) Pub. No.: US 2026/0142108 A1
(43) Pub. Date: May 21, 2026

(54) ECONOMIZING ELECTROMECHANICAL CONTACTORS

(71) Applicant: SENSATA TECHNOLOGIES, INC., ATTLEBORO, MA (US)

(72) Inventors: THOMAS GERJEN HENDRIK KOUWEN, VENTURA, CA (US); GREGORY S. LYONS, VICTORIA (CA)

(21) Appl. No.: 19/119,400

(22) PCT Filed: Oct. 20, 2023
(86) PCT No.: PCT/US2023/035594

§ 371 Date: Apr. 8, 2025

Related U.S. Application Data
(60) Provisional application No. 63/418,018, filed on Oct. 20, 2022.

(51) Int. Cl. H01H 47/04

(52) U.S. Cl. CPC H01H 47/04

(57) ABSTRACT

Apparatuses, methods, and computer program products for economizing electromechanical contactors are disclosed. In a particular embodiment, an electromechanical contactor comprises a moveable contact configured for switching between a non-actuated position and an actuated position by an actuator assembly. The electromechanical contactor also includes two or more fixed contacts that are configured to be engaged with the moveable contact when the moveable contact is in the actuated position and to be disengaged with the moveable contact when the moveable contact is the non-actuated position. In this embodiment, the electromechanical contactor also includes a motion sensor configured to detect motion of the electromechanical contactor and provide to a controller, information regarding the motion of the electromechanical contactor.

### BACKGROUND

Electromechanical switching devices, such as contactors and relays, are designed to carry certain amount of electrical current for certain periods of time. Such devices are particularly important in electric vehicles. Some of these devices utilize a moveable contact that engages and electrically couples two fixed contacts when the moveable contact is in a closed, or actuated, position. The movable contact is held in the closed position by a holding force provided by an actuator assembly. In some examples, the actuator assembly is motivated by an electromagnetic field generated by a solenoid. In the open, or non-actuated, position, the holding force is removed or substantially reduced such that moveable contact is biased away from the fixed contacts.

In some applications, such as in electric vehicle applications, the electromechanical switching device may be exposed to jarring or vibration motion that could potentially cause the moveable contact to disengage the fixed contacts prematurely, which could potentially cause damage to connected components. To address this, the electromechanical switching devices are specified to utilize a holding force that is sufficient to avoid a worst-case situation in which the moveable contact prematurely disengages. However, such worst-case situations are infrequently encountered, and powering the solenoid to generate this high holding force wastes energy when a lower holding force is sufficient.

### SUMMARY

Apparatuses, methods, and computer program products for economizing electromechanical contactors are disclosed in which a motion sensor is employed to identify conditions that do or do not require a high holding force. When it is determined that the low holding force is sufficient, the low holding force is applied and thus excess power required to maintain the high holding force can be conserved.

In a particular embodiment, economizing electromechanical contactors includes an electromechanical contactor having a moveable contact configured for switching between a non-actuated position and an actuated position by an actuator assembly. The electromechanical contactor also includes two or more fixed contacts that are configured to be engaged with the moveable contact when the moveable contact is in the actuated position and to be disengaged with the moveable contact when the moveable contact is the non-actuated position. In this embodiment, the electromechanical contactor also includes a motion sensor configured to detect motion of the electromechanical contactor and provide to a controller, information regarding the motion of the electromechanical contactor.

In another embodiment, a controller for economizing an electromechanical contactor is disclosed that is configured to control a current supplied to a solenoid of an electromechanical contactor. The controller is also configured to determine, based on information from a motion sensor of the electromechanical contactor, that motion of the electromechanical contactor has exceeded a threshold value. In response determining that the motion of the electromechanical contactor has exceeded the threshold value, the controller increases the current supplied to the solenoid of the electromechanical contactor.

In another embodiment, a method of economizing an electromechanical contactor is disclosed that includes controlling, by an economizing controller, current supplied to a solenoid of an electromechanical contactor. The method also includes determining, by the economizing controller based on information from a motion sensor of the electromechanical contactor, that motion of the electromechanical contactor has exceeded a threshold value. In this embodiment, the method also includes increasing, by the economizing controller, the current supplied to the solenoid of the electromechanical contactor in response to determining that the motion of the electromechanical contactor has exceeded the threshold value.

In another embodiment, a method of economizing an electromechanical contactor is disclosed that includes detecting, by a motion sensor, motion of an electromechanical contactor. The method also includes providing, by the motion sensor, information relating to the motion of the electromechanical contactor to a controller.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a sectional view of an example electromechanical contactor configured for economizing according to at least one embodiment of the present disclosure.

FIG. 2 is a diagram of an example system for economizing electromechanical contactors according to at least one embodiment of the present disclosure.

FIG. 3 is a diagram of another example electromechanical contactor configured for economizing according to at least one embodiment of the present disclosure.

FIG. 4 is a flowchart of an example method of a controller economizing electromechanical contactors according to at least one embodiment of the present disclosure.

FIG. 5 is a flowchart of another example method of a motion sensor economizing electromechanical contactors according to at least one embodiment of the present disclosure.

FIG. 6 is a flowchart of another example method of a controller economizing electromechanical contactors according to at least one embodiment of the present disclosure.

### DETAILED DESCRIPTION

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

Some examples of an electromechanical contactor use a solenoid to actuate a moveable contact assembly that makes contact between two fixed contacts, allowing for electric current to flow. For example, the solenoid includes of a coil of wound conductive material (copper, aluminum) with a hollow center. In the center, a plunger can be actuated through the application of an electrical current through the coil. The minimum current through the coil is determined by the holding force required to keep the high voltage movable assembly in place. Reducing this current too much may lead to unintentional disconnects of the lines that power the connected load, leading to serious safety risks in vehicles. For this reason, holding currents are set sufficiently high to not pose a risk of unintentional disconnects. This hold current level is high enough to prevent disconnect even in the most far-out shock situations.

However, while the current level is set high enough that even the most unlikely shock situations do not lead to unintended disconnect, these events rarely occur. Thus, power is wasted by keeping the coil at a high current level. Lowering the current supplied to the coil and thus lowering the holding capability of the high voltage electromechanical connector assembly would not matter for 99% of the mission profile for the contactor. However, during the 1% of the mission profile, it is potentially catastrophic. If the contactor is capable of “knowing” if is subjected to those rare but catastrophic shock forces, the contactor could (temporarily) increase power to the coil. This will temporarily guarantee a higher holding force, preventing unintentional disconnects. The controllers should be able to raise the current within a couple milliseconds, thus requiring a low inductance coil.

In accordance with embodiments of the present disclosure, a motion sensor is associated with an electromechanical contactor and measures the level of acceleration/vibration/shock the contactor is subjected to. In a particular embodiment, an accelerometer disposed in or on the contactor measures the acceleration level in the direction of a plunger. When the accelerometer detects an acceleration above a threshold (Ath), the accelerometer will register this trigger and communicate a signal to the microcontroller, which will in turn increase the current to the coil. The threshold may be application specific, and should be set such that it is sufficiently low to prevent unintentional disconnects, but high enough to not erratically trigger.

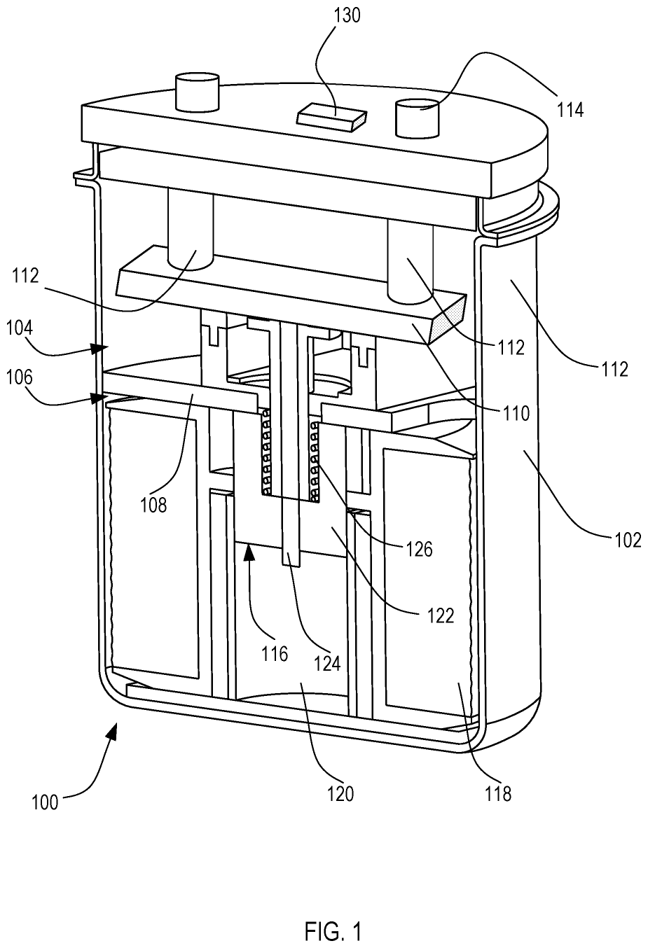

For further explanation, FIG. 1 sets forth a sectional view of an example electromechanical contactor 100 according to at least one embodiment of the present disclosure. The electromechanical contactor 100 includes a housing 102 having an upper portion 104 and a lower portion 106 partitioned by a separator 108. At least one moveable contact 110 and at least one fixed contact 112 are disposed within the upper portion 104 of the housing 102. As shown in FIG. 1, the electromechanical contactor 100 includes two fixed contacts 112, and when the electromechanical contactor 100 is in the actuated state the moveable contact 110 engages the fixed contacts 112 to allow current to pass through the fixed contacts 112 through the moveable contact 110. In the example of FIG. 1, the fixed contacts 112 are electrically coupled to one or more external terminals 114 on the housing 102 for connection to an electrical component. When the electromechanical contactor 100 is actuated, the moveable contact 110 is driven toward and held in contact with the fixed contacts 112 by an actuator assembly 116 described in more detail below.

The lower portion 106 of the housing includes a solenoid 118. For example, the solenoid 118 can be a metal coil wound around a coil bobbin. The solenoid 118 surrounds an actuator cavity 120 that houses at least part of the actuator assembly 116. For example, the actuator cavity 120 can be defined within the center of the coil bobbin. The actuator assembly 116 includes a metal plunger 122 affixed to a plunger shaft 124. The plunger 122 is disposed within the actuator cavity 120. The plunger shaft 124 extends from the plunger 122 in the actuator cavity 120 through the separator 108 to the upper portion 104 of the housing 102, where the plunger shaft 124 interfaces with the moveable contact 110. In some examples, the plunger shaft 124 is affixed to the moveable contact 110. The actuator assembly 116 also includes a plunger spring 126 disposed between the plunger 122 and the separator 108.

In the non-actuated state, the moveable contact 110 is in a non-actuated position where the moveable contact 110 is separated from the fixed contacts 112. That is, the moveable contact is held in a position of non-contact with the fixed contacts 112. For example, the plunger spring 126 may apply a bias force against the plunger 122 and the separator 108 to keep the moveable contact 110 out of contact with the fixed contacts 112 in the non-actuated state. In the actuated state, a current is applied to the solenoid 118, which generates an electromagnetic field that motivates the plunger 122 toward the separator 108, thereby overcoming the bias force applied by the plunger spring 126. The movement of the plunger 122 drives the plunger shaft 124, and thus drives the moveable contact 110, toward the fixed contacts 112, until the moveable contact 110 contacts the fixed contacts 112.

In the actuated state, the strength of the electromagnetic field and resulting force applied by the plunger shaft on the moveable contact 110 (the holding force) must be sufficient to hold the moveable contact 110 in contact with the fixed contacts 112 even if the electromechanical contactor is jarred by sudden movement; otherwise, the circuit interruption may cause damage to electrical components. However, as discussed above, such jarring movements may be uncommon. Thus, a significant amount of energy is wasted by applying a significant amount of current in the solenoid 118 in anticipation of such rare events. Nevertheless, the risk of damage to electrical components may be unacceptable.

To address this problem, the electromechanical contactor 100 also includes a motion sensor 130 disposed on or within the housing 102 of the electromechanical contactor 100. The motion sensor 130 detects the force of movement of the electromechanical contactor 100 along the axis of the plunger shaft 124. For example, the motion sensor 130 can be an accelerometer, a shock sensor, or the like. The motion sensor 130 may be a micro electromechanical (MEM) sensor that generates an electrical signal in proportion to a magnitude of the detected acceleration. When the magnitude of the detected acceleration along the axis of the plunger shaft 124 exceeds a particular threshold, the current flowing through the solenoid 118 is increased to apply more force on the plunger/plunger shaft, which in turn provides more force on the moveable contact 110 to hold the moveable contact 110 in contact with the fixed contacts 112. In some examples, the motion sensor 130 is coupled to a microcontroller that controls the amount of current flowing to through the solenoid 118. When the microcontroller detects that a voltage of the signal from the motion sensor 130 is above a target threshold, the microcontroller increases the current in the solenoid 118. Thus, the electromechanical contactor 100 may normally employ a lower holding force, during a standard operation, relative to a higher holding force that is employed in a compensation operation where the motion sensor 130 detects that the electromechanical contactor 100 is being subjected to severe jarring movement. Through selective application of the higher holding force, the amount of energy required to hold the electromechanical contactor 100 in the actuated state is lower, due to less current applied to the solenoid.

In the example of FIG. 1, the motion sensor is disposed on the exterior of the housing. However, the motion sensor 130 may be located within or on any part of the housing 102 of the electromechanical contactor 100 where the motion sensor 130 detects motion along the axis of the plunger shaft 124. In some examples, the motion sensor 130 and the microcontroller that controls the current flow to the solenoid 118 are integrated in the same device.

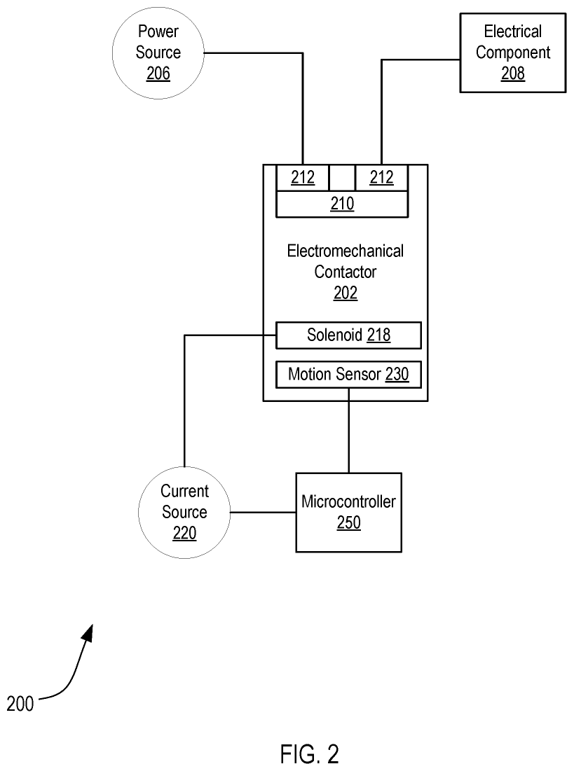

For further explanation, FIG. 2 sets forth a system diagram 200 for economizing an electromechanical contactor 202 according to at least one embodiment of the present disclosure. For example, the electromechanical contactor 202 may be similar to the electromechanical contactor 100 in FIG. 1. In some examples, the electromechanical contactor 202 includes a movable contact 210 that contacts, in an actuated position, fixed terminals 212, as discussed above. When the electromechanical contactor 202 is actuated, the fixed terminals and the moveable contact electrically couple a power source 206 to an electrical component 208. When the electromechanical contactor 202 is in the non-actuated state, the circuit between the power source 206 and the electrical component 208 is broken. In some examples, the electromechanical contactor 202 also includes a solenoid 218 that is powered by a current source 220, where the solenoid motivates an actuator to move the moveable contact. A microcontroller 250 controls the flow of current from the current source 220 to the solenoid, which affects the force applied to the actuator. The microcontroller 250 is also electrically coupled to a motion sensor 230 (e.g., an accelerometer). In some examples, the motion sensor 230 is disposed on or within the electromechanical contactor 202. In other examples, the motion sensor 230 is disposed on a separate structure (not shown) adjacent to the electromechanical contactor 202.

The microcontroller 250 can be implemented by a variety of devices. In various examples, the microcontroller 250 is an Application Specific Integrated Circuit (ASIC), a Field Programmable Gate Array (FPGA), a processor coupled to a memory device (e.g., a read-only memory (ROM)) that stores processor-executable instructions, or some other semiconductor device that carries out the operations detailed below. The microcontroller 250 is configured to control the flow of current between the current source 220 and the solenoid 218. In standard operation, the microcontroller 250 controls the current in accordance with an amount of current required by the solenoid 218 to generate a magnetic field sufficient to actuate an actuator assembly to provide a holding force that holds the moveable contact 210 in contact with the fixed terminals 212. Stated another way, the current Is during standard operation is proportional to a holding force Fs provided by the actuator assembly. In some examples, the microcontroller 250 samples signals generated by the motion sensor 230. For example, the motion sensor 230 generates a voltage proportional to a force of motion (e.g., vibration, acceleration, etc.) measured by the motion sensor 230, which is sampled by the microcontroller 250. In other examples, the motion sensor 230 transmits a trigger signal in response to detecting that a degree of motion (e.g., acceleration) exceeds a threshold level. When the signal from the motion sensor 230 exceeds a threshold value (e.g., a threshold voltage) or when the microcontroller receives the trigger signal, the microcontroller 250 controls an increase in the current flow from the current source 220 to the solenoid 218, which increases the holding force applied by the actuator assembly on the moveable contact 210. Stated another way, the increased current I_{c} during a compensation operation (to counteract motion forces applied to the actuator assembly resulting from acceleration or vibration) is proportional to an increased holding force F_{c} provided by the actuator assembly, where I_{c}>Iₛ and F_{c}>Fₛ.

In a particular example, an accelerometer on the contactor 202 measures the acceleration level in the direction of the plunger. When the accelerometer detects an acceleration above a threshold, the accelerometer registers the event and communicates this information to the microcontroller 250 which will in turn increase the current to the solenoid to generate a high holding force. Otherwise, the current in the solenoid is not increased and a low holding force is maintained.

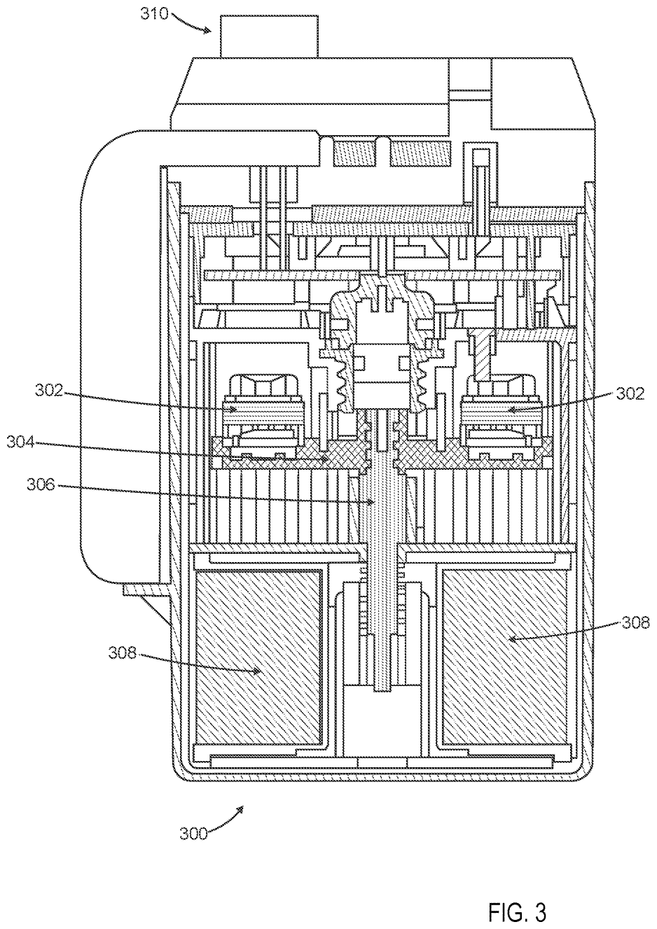

For further explanation, FIG. 3 sets forth another example electromechanical contactor 300 according to at least one embodiment of the present disclosure. The example electromechanical contactor 300 includes high voltage contact pins 302, a high voltage moving assembly 304, a plunger 306, an actuator coil 308, and a motion sensor 310.

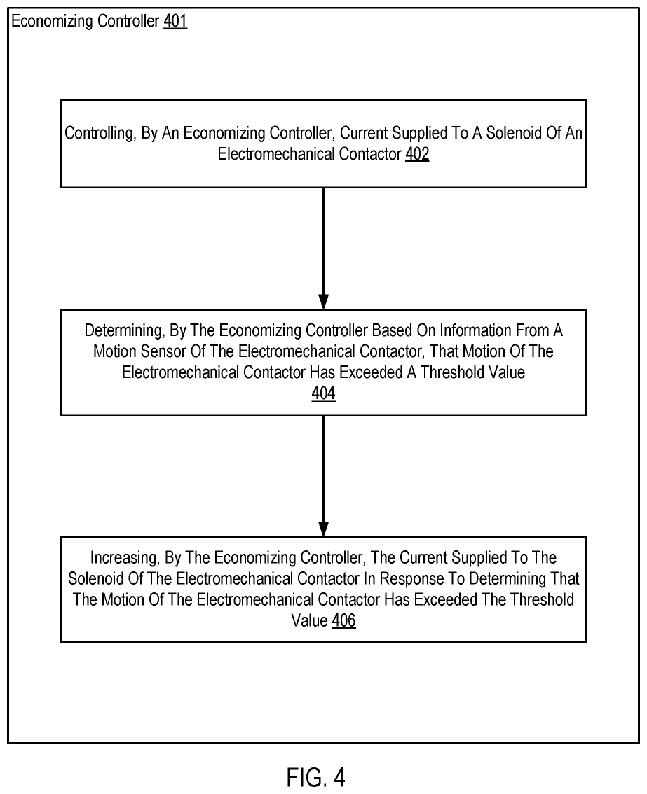

For further explanation, FIG. 4 sets forth a flow chart illustrating an example method of a controller for economizing an electromechanical contactor according to at least one embodiment of the present disclosure. The example method of FIG. 4 includes controlling 402, by an economizing controller 401, current supplied to a solenoid of an electromechanical contactor. In some examples, the economizing controller 401 receives a signal to actuate the electromechanical contactor. In response, the economizing controller 401 regulates a current flow from a current source to the solenoid in accordance with a predetermined current level for a low holding force of the electromechanical contactor. The electromagnetic field generated by the solenoid acts on a plunger driving an actuator assembly, which moves the moveable contact into the closed position.

The method of FIG. 4 also includes determining 404, by the economizing controller 401 based on information from a motion sensor of the electromechanical contactor, that motion of the electromechanical contactor has exceeded a threshold value. In some examples, the economizing controller 401 samples signals from the motion sensor (e.g., acceleration signals) and compares them to a threshold value for acceleration of the electromechanical contactor. In other examples, the economizing controller 401 receives a trigger signal from the motion sensor indicating that detected motion (e.g., acceleration) of the electromechanical contactor has exceeded a threshold value.

The method of FIG. 4 also includes increasing 406, by the economizing controller 401, the current supplied to the solenoid of the electromechanical contactor in response to determining that the motion of the electromechanical contactor has exceeded the threshold value. In some examples, the economizing controller 401 regulates the flow of current from the current source to the solenoid in accordance with a predetermined current level for a high holding force of the electromechanical contactor. The increased current flow to the solenoid increases the holding force applied by the actuator assembly on a moveable contact, as discussed above.

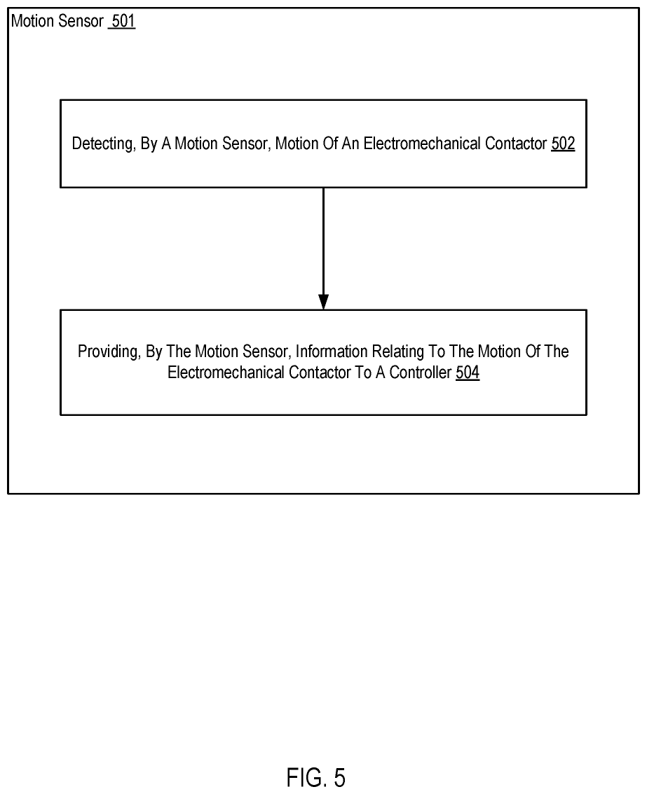

For further explanation, FIG. 5 sets forth a flow chart illustrating an example method of a motion sensor for economizing for an electromechanical contactor according to at least one embodiment of the present disclosure. The method of FIG. 5 includes detecting 502, by a motion sensor 501, motion of an electromechanical contactor. In various examples, the motion sensor 501 is an accelerometer, a shock sensor, or a vibration sensor. In some examples, detecting the motion includes generating an electrical signal indicative of the magnitude of the motion. In some examples, detecting 502 the motion includes determining whether a magnitude of the motion exceeds a predetermined threshold.

The method of FIG. 5 providing 504, by the motion sensor 501, information relating to the motion of the electromechanical contactor to a controller. In some examples, the motion sensor 501 provides 504 the information to the controller in the form of an electrical signal indicative of the magnitude of the motion. In some examples, the motion sensor 501 provides 504 the information as a trigger signal indicating that the detected motion exceeds a threshold value.

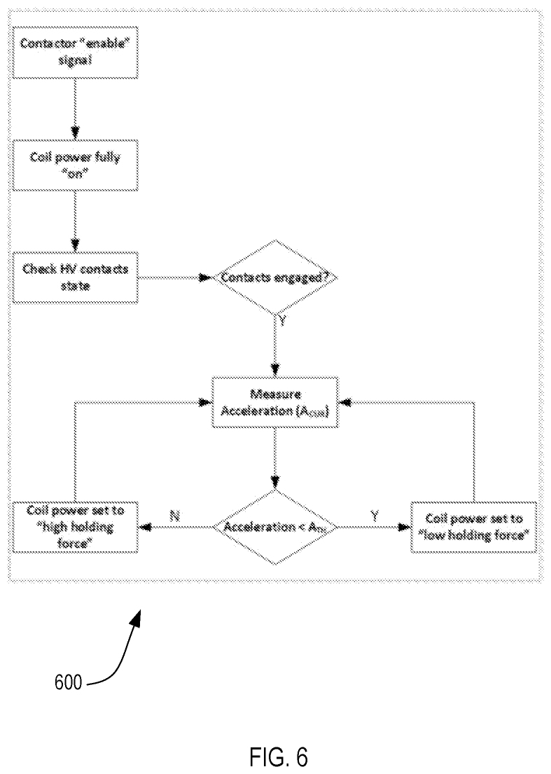

For further explanation, FIG. 6 sets forth a flow chart 600 illustrating another example method of a controller for economizing an electromechanical contactor according to at least one embodiment of the present disclosure. The method of FIG. 6 includes a controller receiving a contactor “enable” signal. In response to receiving the contactor “enable signal,” the controller turns a solenoid coil fully on. The controller then checks the high voltage contact state. If the contracts are engaged, the controller utilizes a motion detector to measure an acceleration of the electromechanical contactor. If the acceleration is less than an acceleration threshold, the controller sets the coil power to a “low holding force”. If the acceleration is greater than the acceleration threshold, the controller sets the coil power to a “high holding force”. The method continues for both outcomes with the controller continuing to measure the acceleration as indicated by a motion detector.

Some embodiments of the present invention are described largely in the context of a fully functional controller. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will also recognize that, although some of the exemplary embodiments described in this specification are oriented to software installed and executing on computer hardware, nevertheless, alternative embodiments implemented as firmware or as hardware are well within the scope of the present invention.

The present invention may be a system, an apparatus, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or other devices to cause a series of operational steps to be performed on the computer, other programmable apparatuses or other devices to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, apparatuses, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to embodiments, those skilled in the art will readily appreciate that various changes and/or modifications can be made to the subject technology without departing from the spirit or scope of the subject technology. For example, each claim may depend on any or all claims in a multiple dependent manner even though such has not been originally claimed.

Advantages and features of the present disclosure can be further described by the following statements:
1. An electromechanical contactor comprising: a moveable contact configured for switching between a non-actuated position and an actuated position by an actuator assembly;
two or more fixed contacts that are configured to be engaged with the moveable contact when the moveable contact is in the actuated position and to be disengaged with the moveable contact when the moveable contact is the non-actuated position; and a motion sensor configured to detect motion of the electromechanical contactor and provide to a controller, information regarding the motion of the electromechanical contactor.
2. The electromechanical contactor of statement 1, further comprising a solenoid; wherein the actuator assembly is moved along an axis by an electromagnetic field generated by the solenoid.
3. The electromechanical contactor of statement 1 or 2, wherein the motion is detected along the axis.
4. The electromechanical contactor of any of statements 1-3, wherein the motion sensor is at least one of an accelerometer, a vibration sensor, and a shock sensor.
5. The electromechanical contactor of any of statements 1-4, wherein the information includes an electrical signal indicative of a magnitude of the detected motion.
6. The electromechanical contactor of any of statements 1-5, wherein the information includes an electrical signal indicating that a threshold degree of motion has been detected.
7. The electromechanical contactor of any of statements 1-6, wherein the motion sensor is configured to compare a current degree of motion detected by the motion sensor to a threshold value.
8. The electromechanical contactor of any of statements 1-7, wherein the motion sensor is disposed within a housing of the electromechanical contactor.
9. The electromechanical contactor of any of statements 1-8, wherein the motion sensor is disposed on a surface of a housing of the electromechanical contactor.
10. The electromechanical contactor of any of statements 1-9, wherein the actuator assembly includes a plunger, a plunger shaft, and a plunger spring.
11. A controller for economizing an electromechanical contactor, the controller configured to: control a current supplied to a solenoid of an electromechanical contactor; determine, based on information from a motion sensor of the electromechanical contactor, that motion of the electromechanical contactor has exceeded a threshold value; and increase the current supplied to the solenoid of the electromechanical contactor in response to determining that the motion of the electromechanical contactor has exceeded the threshold value.
12. The controller of statement 11, wherein determining that motion of the electromechanical contactor has exceeded a threshold value is based on a sampled signal generated by the motion sensor.
13. The controller of statements 11 or 12, wherein determining that motion of the electromechanical contactor has exceeded a threshold value is based on a trigger signal generated by the motion sensor that indicates the threshold value has been exceeded.
14. The controller of any of statements 11-13, wherein the information from the motion sensor is acceleration information measured along an axis of movement of a moveable contact of the electromechanical contactor.
15. The controller of any of statements 11-14, wherein the controller regulates current according to a first current level for a low holding force and a second current level for a high holding force.
16. A method of economizing an electromechanical contactor, the method comprising: controlling, by an economizing controller, current supplied to a solenoid of an electromechanical contactor; determining, by the economizing controller based on information from a motion sensor of the electromechanical contactor, that motion of the electromechanical contactor has exceeded a threshold value; and increasing, by the economizing controller, the current supplied to the solenoid of the electromechanical contactor in response to determining that the motion of the electromechanical contactor has exceeded the threshold value.
17. The method of statement 16, wherein determining that motion of the electromechanical contactor has exceeded a threshold value is based on a sampled signal generated by the motion sensor.
18. The method of statement 16 or 17, wherein determining that motion of the electromechanical contactor has exceeded a threshold value is based on a trigger signal generated by the motion sensor that indicates the threshold value has been exceeded.
19. The method of any of statements 16-18, wherein the information from the motion sensor is acceleration information measured along an axis of movement of a moveable contact of the electromechanical contactor.
20. The method of any of statements 16-19, wherein the controller regulates current according to a first current level for a low holding force and a second current level for a high holding force.
21. A method of economizing an electromechanical contactor, the method comprising:
   detecting, by a motion sensor, motion of an electromechanical contactor; and providing to a controller, by the motion sensor, information relating to the motion of the electromechanical contactor.
22. The method of statement 21, wherein the information includes an electrical signal indicative of a magnitude of the detected motion.
23. The method of statement 21 or 22, wherein the information includes an electrical signal indicating that a threshold degree of motion has been detected.

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. An electromechanical contactor comprising:
a moveable contact configured for switching between a non-actuated position and an actuated position by an actuator assembly;
two or more fixed contacts that are configured to be engaged with the moveable contact when the moveable contact is in the actuated position and to be disengaged with the moveable contact when the moveable contact is the non-actuated position; and
a motion sensor configured to detect motion of the electromechanical contactor and provide to a controller, information regarding the motion of the electromechanical contactor.

2. The electromechanical contactor of claim 1, further comprising a solenoid; wherein the actuator assembly is moved along an axis by an electromagnetic field generated by the solenoid.

3. The electromechanical contactor of claim 2, wherein the motion is detected along the axis.

4. The electromechanical contactor of claim 1, wherein the motion sensor is at least one of an accelerometer, a vibration sensor, and a shock sensor.

5. The electromechanical contactor of claim 1, wherein the information includes an electrical signal indicative of a magnitude of the detected motion.

6. The electromechanical contactor of claim 1, wherein the information includes an electrical signal indicating that a threshold degree of motion has been detected.

7. The electromechanical contactor of claim 6, wherein the motion sensor is configured to compare a current degree of motion detected by the motion sensor to a threshold value.

8. The electromechanical contactor of claim 1, wherein the motion sensor is disposed within a housing of the electromechanical contactor.

9. The electromechanical contactor of claim 1, wherein the motion sensor is disposed on a surface of a housing of the electromechanical contactor.

10. The electromechanical contactor of claim 1, wherein the actuator assembly includes a plunger, a plunger shaft, and a plunger spring.

11. A controller for economizing an electromechanical contactor, the controller configured to:
control a current supplied to a solenoid of an electromechanical contactor;
determine, based on information from a motion sensor of the electromechanical contactor, that motion of the electromechanical contactor has exceeded a threshold value; and
increase the current supplied to the solenoid of the electromechanical contactor in response to determining that the motion of the electromechanical contactor has exceeded the threshold value.

12. The controller of claim 11, wherein determining that motion of the electromechanical contactor has exceeded a threshold value is based on a sampled signal generated by the motion sensor.

13. The controller of claim 11, wherein determining that motion of the electromechanical contactor has exceeded a threshold value is based on a trigger signal generated by the motion sensor that indicates the threshold value has been exceeded.

14. The controller of claim 11, wherein the information from the motion sensor is acceleration information measured along an axis of movement of a moveable contact of the electromechanical contactor.

15. The controller of claim 11, wherein the controller regulates current according to a first current level for a low holding force and a second current level for a high holding force.

16. A method of economizing an electromechanical contactor, the method comprising:
controlling, by an economizing controller, current supplied to a solenoid of an electromechanical contactor;
determining, by the economizing controller based on information from a motion sensor of the electromechanical contactor, that motion of the electromechanical contactor has exceeded a threshold value; and
increasing, by the economizing controller, the current supplied to the solenoid of the electromechanical contactor in response to determining that the motion of the electromechanical contactor has exceeded the threshold value.

17. The method of claim 16, wherein determining that motion of the electromechanical contactor has exceeded a threshold value is based on a sampled signal generated by the motion sensor.

18. The method of claim 16, wherein determining that motion of the electromechanical contactor has exceeded a threshold value is based on a trigger signal generated by the motion sensor that indicates the threshold value has been exceeded.

19. The method of claim 16, wherein the information from the motion sensor is acceleration information measured along an axis of movement of a moveable contact of the electromechanical contactor.

20. The method of claim 16, wherein the controller regulates current according to a first current level for a low holding force and a second current level for a high holding force.

21. A method of economizing an electromechanical contactor, the method comprising:
detecting, by a motion sensor, motion of an electromechanical contactor; and
providing to a controller, by the motion sensor, information relating to the motion of the electromechanical contactor.

22. The method of claim 21, wherein the information includes an electrical signal indicative of a magnitude of the detected motion.

23. The method of claim 21, wherein the information includes an electrical signal indicating that a threshold degree of motion has been detected.
